(19) United States
(12) Patent Application Publication
(10) Pub. No.: US 2009/0199115 A1
(43) Pub. Date: Aug. 6, 2009

(54) SYSTEM AND METHOD FOR UTILIZING TILES IN A SEARCH RESULTS PAGE

(76) Inventor: Vik Singh, San Jose, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 12/023,925

(22) Filed: Jan. 31, 2008

(51) Int. Cl. G06F 3/048; G06F 7/06; G06F 17/30

(52) U.S. Cl. 715/764; 707/5; 707/E17.017

(57) ABSTRACT

The present invention is directed towards systems, methods and computer program products for organizing a search result set into one or more tiles for display on a search results page. The method according to one embodiment of the present invention comprises receiving a search request from a client device, querying one or more search corpora to identify a search result set that is responsive to the search request and categorizing the search result set into one or more categories. One or more tiles are generated, a given tile corresponding to a given category, for organizing the search result set in accordance with the one or more tiles on the basis of a category corresponding to a given tile. The one or more tiles are displayed on the search results page for presentation at the client device.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The invention disclosed herein relates generally to the presentation of search results in an organized fashion on a search results page. More specifically, the present invention is directed towards systems, methods and computer program products for providing one or more tiles on a search results page to organize one or more search results in an organized and categorized fashion.

### BACKGROUND OF THE INVENTION

As use of the Internet as an architecture for the maintenance and retrieval of information, the number of content items available has grown at an increasing rate. The vast number of content items available on the Internet, however, has led to frustration on the part of users attempting to locate information that is relevant to their informational needs. Accordingly, search engines have been developed to facilitate the information retrieval process.

A search engine processes and indexes content items available on the Internet. Using an index, the search engine is operative to locate content items that are responsive to one or more search terms or keywords that the user provides to the search engine. In response, the search engine provides the user with a result set comprising list of one or more content items that are relevant to the search terms that the search engine receives. Typically, the result set is a numerically ordered listing of content items, which the search engine may place in order of relevance to the user query.

Unfortunately, there are many instances where a numerically ordered listing of content items that the search engine determines are relevant to the search query is an ineffective method of presenting the search results. For example, where a given search term is of an ambiguous context, or comprises multiple relevant contexts, the search engine may not highly rank the context for which the user is searching. In an effort to address this problem, search engines have attempted to implement “federated search”.

When implementing federated search, the user enters a search query using a search interface that the search engine provides, which sends the query to a plurality of databases in an enumerated list. Access details for the individual databases must be preset in the portal by its owner. Other methods of organizing searches of multiple data sources include aggregators and metasearch engines. Many of these methods require a user to provide access information for various data sources and present results in a fixed manner, regardless of the result set that a particular database returns. Also, there is no mechanism to dynamically control the presentation of the search results on the basis of the query and content items in the result set.

The process of searching for content items on a network that are relevant to a search request is therefore a time consuming and complex. Accordingly, there exists a need for systems, methods and computer program products for using tiles to present content items that are relevant to a search in an organized and categorized fashion.

### SUMMARY OF THE INVENTION

The present invention is directed towards systems, methods and computer program products for organizing a search result set into one or more tiles for display on a search results page. The method according to one embodiment of the present invention comprises receiving a search request from a client device, querying one or more search corpora to identify a search result set that is responsive to the search request and categorizing the search result set into one or more categories. One or more tiles are generated, a given tile corresponding to a given category, and the search result set is organized in accordance with the one or more tiles on the basis of a category corresponding to a given tile. The one or more tiles are displayed on the search results page.

Displaying may comprise presenting one or more interactive controls in conjunction with the given tile, which may comprise presenting one or more interactive controls selected from the set of interactive controls including a more control, an expand control, a close control. Selection of a given interactive control results in the execution of a command associated with the given interactive control. For example, selecting a given interactive control may comprise selecting a close control and executing a command may comprise collapsing a display of the given tile. Similarly, selecting a given interactive control may comprise selecting an expand control and executing a command may comprise expanding a display of the given tile. Still further, selecting a given interactive control may comprise selecting a more control and executing a command may comprise displaying additional search results associated with the given tile.

The present invention is also directed towards computer readable media comprising program code for execution by a programmable processor that instructs the processor to perform a method for organizing a search result set into one or more tiles for display on a search results page. The computer readable media according to one embodiment of the present invention comprises program code for receiving a search request from a client device, program code for querying one or more search corpora to identify a search result set that is responsive to the search request and program code for categorizing the search result set into one or more categories. Program code is provided for generating one or more tiles, a given tile corresponding to a given category, as well as program code for organizing the search result set in accordance with the one or more tiles on the basis of a category corresponding to a given tile. Program code displays the one or more tiles on the search results page.

The program code for displaying may comprise program code for presenting one or more interactive controls in conjunction with the given tile. The program code for presenting the one or more interactive controls may comprise program code for presenting one or more interactive controls selected from the set of interactive controls including a more control, an expand control, a close control. Program code may be provided for selecting a given interactive control, as well as program code for executing a command associated with the given interactive control. The program code for selecting a given interactive control may comprise program code for selecting a close control and the program code for executing a command may comprise program code for collapsing a display of the given tile. Similarly, the program code for selecting a given interactive control may comprise program code for selecting an expand control and the program code for executing a command may comprise program code for expanding a display of the given tile. Still further, the program code for selecting a given interactive control may comprise program code for selecting a more control and the program code for executing a command may comprise program code for displaying additional search results associated with the given tile.

In addition to the foregoing, the present invention is directed towards a system for organizing a search result set into one or more tiles for display on a search results page. The system according to one embodiment of the present invention comprises a search engine operative to receive a search request from a client device and query one or more search corpora to identify a search result set that is responsive to the search request. The system according to the present embodiment also comprises a category module operative to receive the search result set from the search engine and to categorize the search result set into one or more categories. A tile module is also provided, the tile module operative to receive the categorized search result set from the category module to generate one or more tiles, a given tile corresponding to a given category, organize the search result set in accordance with the one or more tiles on the basis of a category corresponding to a given tile and provide the one or more tiles to the search engine for display of the one or more tiles on the search results page.

The tile module may be operative to generate one or more tiles comprising one or more interactive controls, which may be selected from the set of interactive controls including a more control, an expand control, a close control. According to one embodiment, the client device is operative to receive an indication of the selection of a given interactive control and execute a command associated with the given interactive control.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram illustrating a system for providing one or more tiles on a search results page;

FIG. 2 presents a flow diagram illustrating a method for presenting search results organized in one or more tiles for presentation on a search results page on the basis of one or more categories to which the search results belong according to one embodiment of the present invention;

FIG. 3 presents a flow diagram illustrating a method for presenting search results organized in one or more tiles for presentation on a search results page on the basis of one or more verticals from which the search results are obtained according one embodiment of the present invention;

FIG. 4 presents a flow diagram illustrating a method for generating one or more tiles for the organization of search results according to one embodiment of the present invention;

FIG. 5 presents a flow diagram illustrating a method for interacting with a tile on a search results page according to one embodiment of the present invention; and

FIG. 6 is a screen diagram illustrating an interface for presenting search results organized in a plurality of tiles according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

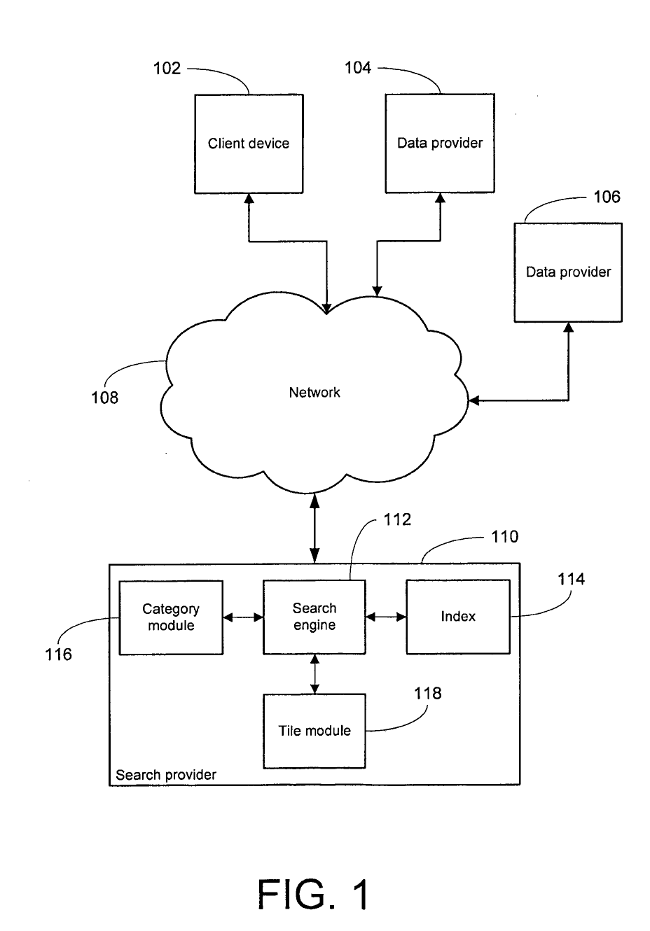

FIG. 1 presents a block diagram depicting a system for system for providing one or more tiles on a search results page. According to the embodiment that FIG. 1 illustrates, at least one client device 102 is communicatively coupled to a network 108, which may include a connection to one or more local or wide area networks, such as the Internet.

A given client device 102 is in communication with a search provider 110 and one or more data providers 104 and 106. In the embodiment that FIG. 1 illustrates, a search provider 110 comprises a search engine 112 operative to receive search requests from client devices 102 and, in response, return appropriate data that is responsive to the incoming search request. In addition to a search engine 112, a search provider 110 according to one embodiment of the present invention further comprises an index 114, a tile module 118 and a category module 116.

A user at a given client device 102 wishing to locate a particular content item that a data provider 104 and 106 is making available on the network 108 transmits a search request to the search engine 112 at the search provider 110. The search request from the client device 102 may take the form of a query comprising one or more search terms or phrases. For example, the query “laptop computer” is a two term query, the query “ultra-portable laptop computer” is a three term query, etc.

The search engine 112 at the search provider 110 receives the search request from the client device 102 and attempts to identify content items that are responsive to the search request. The search engine 112 traverses an index 114, which the search provider 110 may maintain in an index data store, in an attempt to identify responsive content items. According to one embodiment, the index 114 comprises one or more word-location pairs and which the search engine 112 uses to identify content items that comprise the terms contained in the search request. Accordingly, the search engine 112 may locate or otherwise identify a result set comprising one or more content items that fall within the scope of the search request.

The search engine 112 utilizes a category module 116 to identify one or more categories to which a given content item in the result set belongs. According to the embodiment of FIG. 1, the category module receives a given content item (or a reference to a content item, e.g., a URL) from the result set and annotates the content item with category information. Alternatively, the search engine may periodically provide the category module 116 with access to the index 114, in response to which the category module 116 supplements the index 114 with category information. The category module 116 may categorize a given content item using one or more techniques known to those of skill in the art. For example, the category module 116 may implement one or more clustering algorithms to determine a category to which a given content item belongs including, but not limited to, a K-means algorithm, a Fuzzy C-means algorithm, a Hierarchical clustering algorithm, etc. The category module 116 may also utilize other clustering and categorization algorithms known to those of skill in the art.

Alternatively, or in conjunction with clustering, the category module 116 may utilize one or more categorization algorithms known to those of skill in the art. Classification concerns the gathering of training data (e.g., documents or web pages) with regard to a given concept (e.g., travel) and learning a function from the training data that, when given a document/URL pair, is operative to return a probability score that denotes how closely the document relates to the concept. According to one embodiment, the function is used to group results into categories in linear computation time, which results in faster and more accurate document categorization. Because users add category tags to many content items (e.g., via games, editorials, social bookmarking sites, blogs, etc.) the categorization module 116 may utilize these data when categorizing a given content item, which may be useful in the social integration of disparate content items.

The search engine 112 provides the search result set, comprising one or more content items (or links thereto), with category information for a given content item in the search result set, to the tile module 118. The tile module 118 builds or otherwise generates one or more tiles for presenting search results in an organized and categorized fashion. According to one embodiment, a given tile that the tile module 118 generates may comprise an AJAX-based container or similar data structure operative to maintain one or more content items in a given tile. AJAX allows for improved responsiveness and interactivity with content items, such as web pages, by exchanging data without user intervention such that the user need not refresh an entire content item each time a user performs an action on the content item. AJAX is asynchronous in that extra data is requested from the server and loaded in the background without interfering with the display behavior of a content item that the system is displaying to the user.

In addition to the foregoing, the tile module 118 may supplement or annotate a given content item in the result set with tracking information such that the search provider 110 may receive a notification indicating the selection of a given content item, as well as the given tile to which the content item belongs. For example, the tile module 118 may re-write the URL of a given content item. Accordingly, selection of the given content item by a user at a given client device 102 and first directs the client device 102 to a redirection server (not pictured) and then onto the data provider 104 and 106 that is hosting the given content item.

The tile module 118 generates one or more tiles on the basis of one or more content items in the search result set. As is described in greater detail herein, the tile module 118 may also be operative to add one or more tile controls to a given tile, thereby allowing the user to interact with a given tile. A given tile control may be operative to transmit an indication back to the search provider 110 regarding the selection of a given control by the user. The search provider 110 may use feedback that it receives from the user in the form of the selection of content item for use in tuning the categorization of content items by the category module 116.

The search engine 112 receives the one or more tiles comprising the search result set that is responsive to search request of the user. According to one embodiment, the search engine 112 composes the finalized search results page on the basis of the one or more tiles, as well as additional information related to the search results page, such as context or content sensitive advertisements. Alternatively, the tile module 118 may concatenate or otherwise compose the search results page on the basis of the one or more tiles, which the tile module passes to the search engine 112 for finalization or addition of additional information, which may, although not necessarily, also bear a relation to the search request. The search engine provides the finalized search results page to a user at a client device 102 from which the search request originates, thereby allowing the user to selection content items in the result set and access one or more content items available at a given data provider 104 and 106.

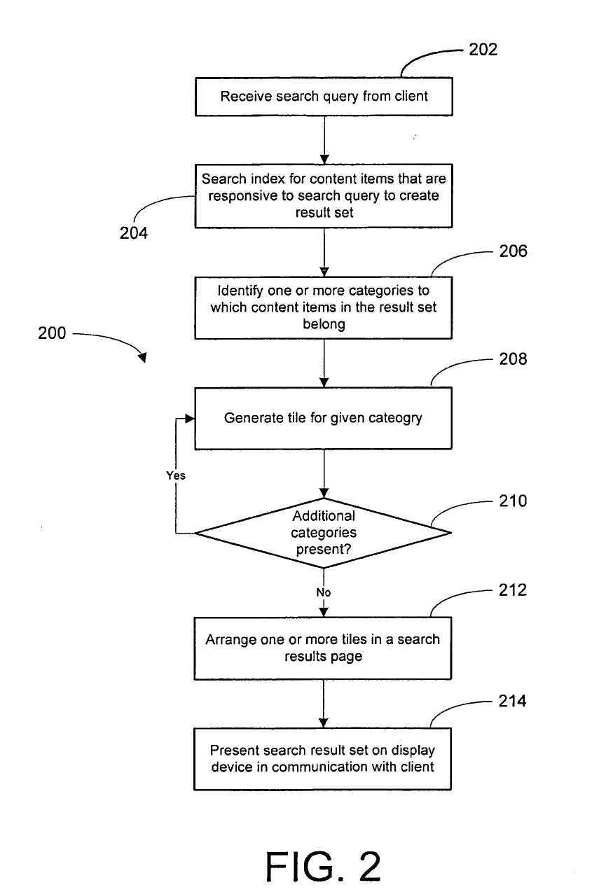

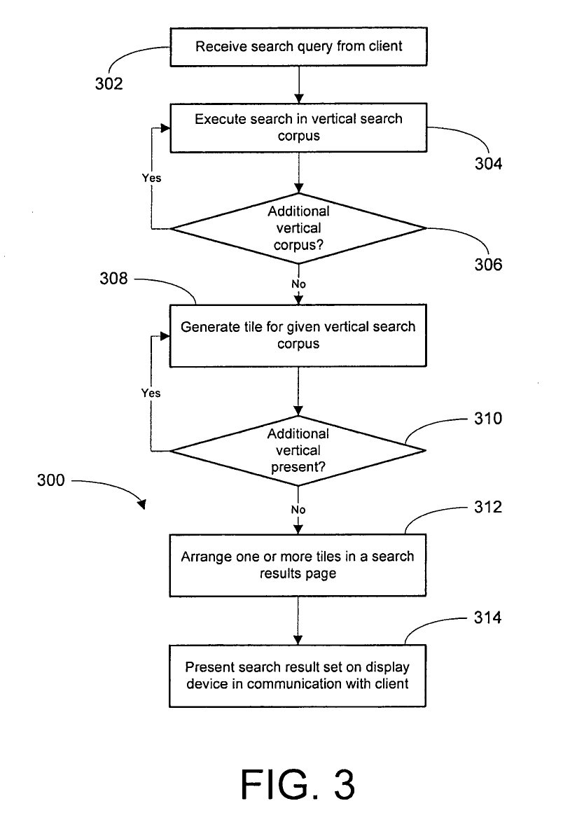

FIGS. 2 and 3 present two embodiments of methods for the creation of tiles for the organization and categorization of content items in a search result set, for example, operating in the architecture of FIG. 1. According to the method of FIG. 2, a search provider or other entity receives a search request from a client device 202, which forms the basis of a search of an index of content items, step 204. The search provider searches the index to identify one or more content items (or links thereto) that are responsive to the search query for inclusion in a result set.

The method continues with the identification of one or more categories to which content items in the result set belong, step 206. According to one embodiment, the search provider passes the result set to a category module, which determines one or more categories to which a given content item in the result set belongs. Alternatively, a content module may periodically annotate content items in the index with category information, thereby allowing the identification of category information when constructing the result.

The method 200 comprises generating a tile for a given category within the result set, steep 208. For example, if one or more content items in the result set fall within the category “computer software,” the method 200 may generate a tile for organization of content items in the tile that belongs to or is otherwise associated with the “computer software” category. A check is performed to determine if additional categories are present in the result set for inclusion in one or more tiles, step 210. According to one embodiment, the method 200 limits the generation of tiles to those categories associated with a number of content items in the result set that exceeds a threshold. The threshold may be of a dynamic nature and determined by probability confidences determined for a given tile. The method 200 may also comprise implementing a threshold to determine the number of results to display within a given tile, which may also be of a dynamic nature. For example, where only one content item in the result set belongs to the “computer software” category, the method 200 may forgo generation of tile for the “computer software” category. Alternatively, method may include such content items in a generic or uncategorized tile. Where additional categories exist, program flow returns to step 208 with the generation of a tile for the additional category.

Where no additional categories are present in the result set that require organization into one or more tiles, step 210, the method 200 proceeds to arrange the one or more tiles in a search results page, 212. According to one embodiment, the search engine that receives the search request from the user also receives the one or more tiles for generation of the finalized search results page, which may include other information in addition to the one or more tiles, e.g., advertising information, which may be related to the content or context of the search request. Alternatively, the search engine may receive the formatted search results page comprising one or more tiles, adding additional information including, but not limited to, advertisements. A client device receives and presents the finalized search results page on a display device that is in communication with the client device, step 214, thereby allowing the user of view the search results in a categorized and organized fashion.

An alternative embodiment of a method for presenting search results organized in one or more tiles for presentation on a search results page, which may be performed in conjunction with foregoing processes, is presented in FIG. 3. The method of FIG. 3 illustrates the generation of one or more tiles on the basis of one or more verticals from which the search results are obtained in accordance with one embodiment of the present invention. The method 300 comprises receive a search query from a client device, step 302.

A search engine receives the search request from the client device and executes a search in a vertical search corpus, step 304. According to one embodiment, a vertical search corpus comprises one or more highly refined databases to index information relating a specific topic, e.g., specific search copra for veterinarians, doctors, patients, job seekers, house hunters, recruiters, travelers and corporate purchasers, etc. After execution of a search in a given vertical search corpus, a check is performed to determine if additional vertical search corpora exist that require searching, step 306. Where additional vertical search corpora exist that require searching, program flow returns to step 304 with the execution of a search in a given additional vertical search corpora.

The method 300 generates a tile for a given vertical search corpus, step 308, where no additional vertical search corpora exist that require searching, step 306. A check is performed to determine if additional verticals are present for inclusion in one or more tiles, step 310. According to one embodiment, the method 300 limits the generation of tiles to those verticals associated with a number of content items in the result set that exceeds a threshold. For example, where only one content item in the result set comes from a vertical directed towards political information, the method 300 may forgo generation of tile for given vertical. Alternatively, method may include such content items in a generic or uncategorized tile. Where additional verticals exist, program flow returns to step 308 with the generation of a tile for the additional vertical.

Where no additional verticals are present in the result set that require organization into one or more tiles, step 310, the method 300 proceeds to arrange the one or more tiles in a search results page, 312. According to one embodiment, the search engine that receives the search request from the user also receives the one or more tiles for generation of the finalized search results page, which may include other information in addition to the one or more tiles, e.g., advertising information, which may be related to the content or context of the search request. Alternatively, the search engine may receive the formatted search results page comprising one or more tiles, adding additional information including, but not limited to, advertisements. A client device receives and presents the finalized search results page on a display device that is in communication with the client device, step 314, thereby allowing the user of view the search results in a categorized and organized fashion.

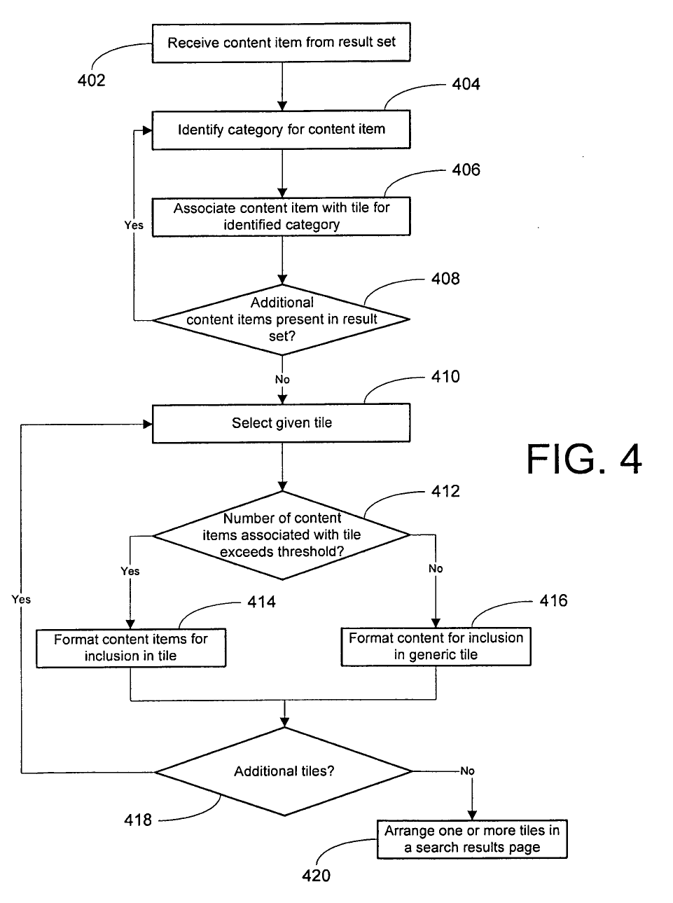

FIG. 4 presents a flow diagram illustrating a method for generating one or more tiles for the organization of search results according to one embodiment of the present invention. The method of FIG. 4 comprises receiving or otherwise selecting a content item from a result set that is responsive to a search request of a user, step 402, and identifying a category for the given content item, step 404. The method 400 continues by associating the given content item with a tile for the identified category, step 406, and performing a check to determine if additional content items are present in the result set, step 408. Where additional items exist in the result set that require processing, program flow returns to step 404 with the identification of a category for a subsequent content item from the result set.

Where no additional items exist in the result set that require processing, step 408, the method continues with the selection of a given tile from the one or more tiles that the method associates with one or more content items, step 410. A check is performed to determine if the number of content items associated with the given tile exceeds a threshold, step 412. For example, assume that a tile exists for the category “political humor” in response to a search request. According to FIG. 4, the method may associate one or more content items with the “political humor” tile and the check at step 412 determines if the number of content items associated with the “political humor” tile exceeds a threshold.

The method 400 proceeds with formatting the content items for inclusion in the tile, step 414, where the number of content items exceeds the threshold, step 412. According to one embodiment, formatting may comprise a visual styling of the content item in the tile, but may further include a rewriting or modification of the URL that identifies the location of the content item on the network, as well as other formatting. For example, URL modification or rewriting may comprise media integration (e.g., image thumbnails, video clips, etc.), as well as enhancing search results with social data (e.g., extracting the number of users who have bookmarked a given page in a social bookmarking site, such as del.icio.us). Where the number of content items does not exceed the threshold, step 412, the content items may be formatted for inclusion in a generic tile, for example, a general web search tile.

Formatting of the given tile is performed, as well as a check to determine if additional tiles exist that require processing, step 418. Where additional tiles exist that require processing, program flow returns to step 410 with the selection of a subsequent tile for processing in accordance with step s412 and 414 or 416. Where no additional tiles exist that require processing, step 418, the one or more tiles are arranged in a search results page, step 420.

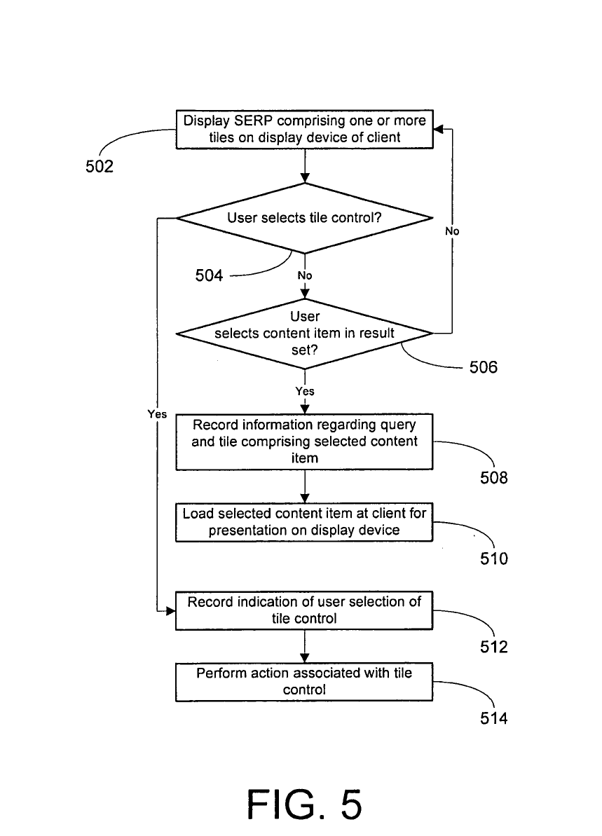

In addition to using tiles to present search results in a organized and categorized fashion, a user may interact with both the content items associated with the tile and one or more tile controls. FIG. 5 presents a flow diagram illustrating a method for interacting with a tile on a search results page according to one embodiment of the present invention. According to FIG. 5, the method comprises displaying a search results page comprising one or more tiles on a display device in communication with a client device, step 502, e.g., a monitor in communication with a personal computer.

The method 500 performs a check to determine if the user selects a tile control that is presented in conjunction with the tile on the search results page, step 504. Where check at step 504 evaluates to true in response to the user selection of tile control, the method 500 records an indication of the user selection of a given tile control, step 512. In conjunction with recording the user selection (which may be used as feedback for tuning the categorization of content items into one or more tiles), the action associated with the tile control that the user selects is performed, step 514. For example, an exemplary time control may be a “close” or “collapse” command to hide or otherwise remove from the search results page content items associated with a given tile. Closing a given tile may indicate that a user believes that the given tile is not a relevant topic or category for the search he or she is performing, which may be used as feedback for future categorization of content items into one or more tiles.

Where the user does not select a tile control, resulting in the check at step 504 evaluating to false, the method 500 performs a check to determine if the user selects a content item form a given tile in the result set on the search results page, step 506. Where the user selects a content item in the result set, information regarding the query and tile comprising the selected content item is recorded, step 508, which according to some embodiments may also comprise recording an indication of the content item that the user selects. Systems and methods according to embodiments of the present invention may use these data as feedback for tuning the categorization of content items into one or more tiles. In conjunction with recording information regarding the selection, the method 500 loads the content item that the user selects at the client device for presentation on a display device, step 510. Where the checks at steps 504 and 506 both evaluate to false, program flow is directed to step 502 with display of the search results page.

In addition to the foregoing, exemplary interactive functions for a give tile include expanding a tile and dragging tiles. For example, where a tile is collapsed or otherwise closed, a user may select an “expand” control to display the results contained in a collapsed tile. If necessary, one or more tiles may be collapsed in response to the user expanding a given tile, as well as expanding one or more tiles in response to a collapse command. A user may also select and drag a given tile to reorder the sequence in which the system displays tiles in response to a given query. As described above, the system may implement these functions using AJAX, thereby eliminating the need to refresh the page that is displaying the result set when presenting the results to the user.

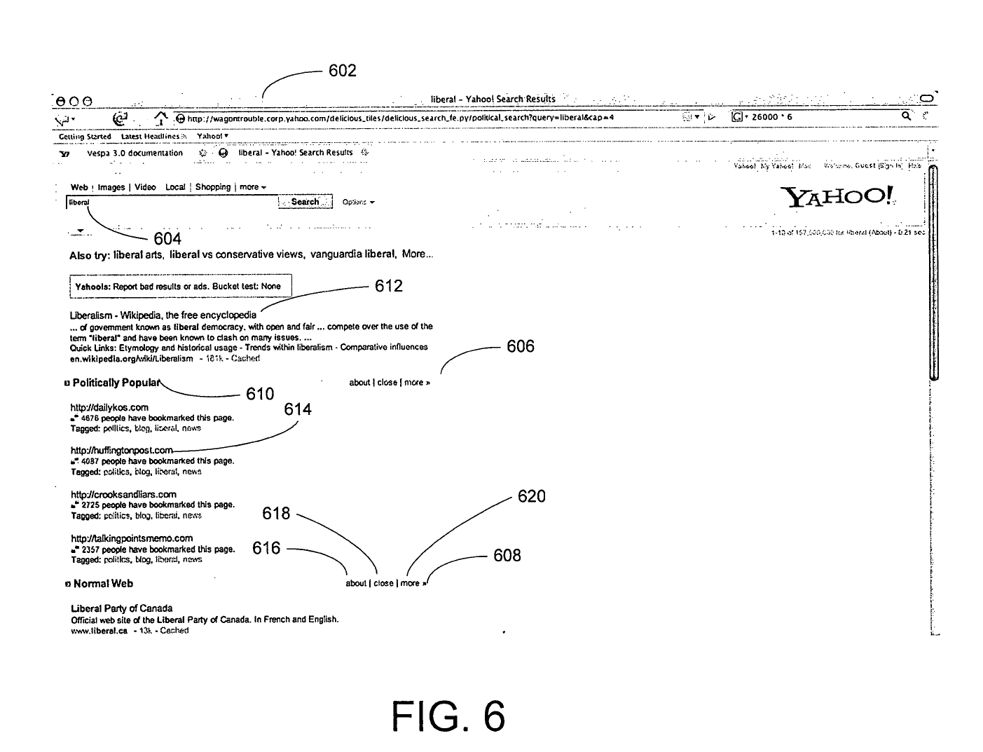

FIG. 6 is a screen diagram illustrating an interface for presenting search results organized in a plurality of tiles according to one embodiment of the present invention. The search results page 602 includes a text entry field that display a search request 604 that the user provides, which in the present example is the query term “liberal”.

According to the embodiment of FIG. 6, a search results page 602 comprises a plurality of tiles 606 and 608. A given search tile 606 and 608 on the search results page 602 is associated with a label 610, which may identify a category to which search results displayed in conjunction with a given tile is directed towards. A first tile 606 in the search results page 602 is directed towards the category “politically popular,” whereas a second search tile in the search results page is directed towards the category “normal web”. Additionally, the search results page may comprise one or more search results from a given vertical data repository 612 or corpus of information, which in the present embodiment is a definition for the term “liberal” from the on-line encyclopedia Wikipedia.

A given tile 606 and 608 may also comprise one or more tile controls that allow the user to interact with a given tile beyond the selection of search results displayed in conjunction with a given tile 606 and 608. FIG. 6 illustrates three tile controls: an about control 616, a close control 618 and a more control 620. Selection of an about control 616 may present the user with additional information regarding a given tile 606 and 608. For example, a data store at the search provider may maintain an association between categories and category description, such that selection of the about control 616 executes program code to present the category description. Selection of a more control 620 may cause the presentation of additional search results associated with a given tile 606 and 608 beyond those that a given tile 606 and 608 initially displays on the search results page 602. Finally, selection of a close control 618 collapses or otherwise removes a given tile 606 and 608 from display on the search results page 602.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for organizing a search result set into one or more tiles for display on a search results page, the method comprising:
receiving a search request from a client device;
querying one or more search corpora to identify a search result set that is responsive to the search request;
categorizing the search result set into one or more categories;
generating one or more tiles, a given tile corresponding to a given category;
organizing the search result set in accordance with the one or more tiles on the basis of a category corresponding to a given tile;
displaying the one or more tiles on the search results page.

2. The method of claim 1 wherein displaying comprises presenting one or more interactive controls in conjunction with the given tile.

3. The method of claim 2 wherein presenting the one or more interactive controls comprises presenting one or more interactive controls selected from the set of interactive controls including a more control, an expand control, a close control.

4. The method 2 comprising:
selecting a given interactive control; and
executing a command associated with the given interactive control.

5. The method of claim 4 wherein selecting a given interactive control comprises selecting a close control and executing a command comprises collapsing a display of the given tile.

6. The method of claim 4 wherein selecting a given interactive control comprises selecting an expand control and executing a command comprises expanding a display of the given tile.

7. The method of claim 4 wherein selecting a given interactive control comprises selecting a more control and executing a command comprises displaying additional search results associated with the given tile.

8. Computer readable media comprising program code for execution by a programmable processor that instructs the processor to perform a method for organizing a search result set into one or more tiles for display on a search results page, the computer readable media comprising:
program code for receiving a search request from a client device;
program code for querying one or more search corpora to identify a search result set that is responsive to the search request;
program code for categorizing the search result set into one or more categories;
program code for generating one or more tiles, a given tile corresponding to a given category;
program code for organizing the search result set in accordance with the one or more tiles on the basis of a category corresponding to a given tile;
program code for displaying the one or more tiles on the search results page.

9. The computer readable media of claim 8 wherein program code for displaying comprises program code for presenting one or more interactive controls in conjunction with the given tile.

10. The computer readable media of claim 9 wherein program code for presenting the one or more interactive controls comprises program code for presenting one or more interactive controls selected from the set of interactive controls including a more control, an expand control, a close control.

11. The computer readable media 9 comprising:
program code for selecting a given interactive control; and
program code for executing a command associated with the given interactive control.

12. The computer readable media of claim 11 wherein program code for selecting a given interactive control comprises program code for selecting a close control and program code for executing a command comprises program code for collapsing a display of the given tile.

13. The computer readable media of claim 11 wherein program code for selecting a given interactive control comprises program code for selecting an expand control and program code for executing a command comprises program code for expanding a display of the given tile.

14. The computer readable media of claim 11 wherein program code for selecting a given interactive control comprises program code for selecting a more control and program code for executing a command comprises program code for displaying additional search results associated with the given tile.

15. A system for organizing a search result set into one or more tiles for display on a search results page, the system comprising:
a search engine operative to receive a search request from a client device and query one or more search corpora to identify a search result set that is responsive to the search request;
a category module operative to receive the search result set from the search engine and to categorize the search result set into one or more categories;
a tile module operative to receive the categorized search result set from the category module to generate one or more tiles, a given tile corresponding to a given category, organize the search result set in accordance with the one or more tiles on the basis of a category corresponding to a given tile and provide the one or more tiles to the search engine for display of the one or more tiles on the search results page.

16. The system of claim 15 wherein the tile module is operative to generate one or more tiles comprising one or more interactive controls.

17. The system of claim 16 wherein the one or more controls are selected from the set of interactive controls including a more control, an expand control, a close control.

18. The system of claim 16 wherein the client device is operative to receive an indication of the selection of a given interactive control and execute a command associated with the given interactive control.
